(19) United States
(12) Patent Application Publication
(10) Pub. No.: US 2016/0041347 A1
(43) Pub. Date: Feb. 11, 2016

(54) CHIP RESISTANT FERRULE

(71) Applicants: Malcolm H. HODGE, (US); Gennady GENCHANOK, (US); MOLEX INCORPORATED, Lisle, IL (US)

(72) Inventors: Malcolm H. HODGE, Chicago, IL (US); Gennady GENCHANOK, Buffalo Grove, IL (US)

(73) Assignee: Molex, LLC, Lisle, IL (US)

(21) Appl. No.: 14/781,820

(22) PCT Filed: Apr. 5, 2013
(86) PCT No.: PCT/US13/35430

§ 371 Date: Oct. 1, 2015

(51) Int. Cl. G02B 6/38

(52) U.S. Cl. CPC G02B 6/3882; G02B 6/3885; G02B 6/3854; G02B 6/3863

(57) ABSTRACT

A multi-fiber ferrule includes a ferrule body made of a first material and has at least one alignment passage in the front face. The alignment passage has first and second sections. An insert is positioned within the first section of the alignment passage and is formed of a second material that is tougher than the first material. The insert has an insert hole coaxial with a central axis of the alignment passage.

The Present Disclosure relates generally to optical fiber ferrules and, more particularly, to optical fiber ferrules having chip resistant alignment recesses.

Optical fibers are typically positioned within ferrules in order to facilitate handling and accurate alignment of the fibers between mating ferrules. One popular type of multi-fiber ferrule is known as an MT ferrule. MT ferrules include one or more rows of holes or bores in which respective ones of a plurality of optical fibers are positioned and a pair of alignment holes or receptacles located in the front face on opposite sides of the plurality of optical fibers. In a pair of mating MT ferrules, one of the ferrules will include a precision guide pin located in each of its alignment holes. During mating of two optical fiber connectors that include such ferrules, the pins of one ferrule are aligned with the alignment holes of the mating ferrule in order to guide the ferrules together and accurately align the mating optical fibers.

MT ferrules may be manufactured by a precision molding process out of a resin such as polyphenylene sulfide (PPS) with an additive such as silica (SiO₂) in order to improve the dimensional characteristics, strength and stability of the ferrule for its desired high precision application. In some applications, the percentage of the SiO₂ by weight may be as great as sixty percent of the material.

While the relatively high percentage of SiO₂ improves certain aspects of the performance of the ferrules, the addition of the SiO₂ also increases the likelihood that the ferrules will chip under certain circumstances. More particularly, during mating of two optical fiber connectors, the connectors are generally aligned and then moved towards each other and moved laterally until the alignment pins from one ferrule align and mate with the alignment holes of the other ferrule. The tips of the alignment pins will typically engage the edges or rim of the alignment holes as the two ferrules are moved relatively towards each other. The engagement of the tips of the alignment pins with the front face of the mating ferrule may cause a portion of the edges or rim of the alignment hole to become chipped or otherwise break away. Chips and similar debris from the ferrule may become positioned between the aligned ferrules and cause a separation between the front faces of the ferrules (and thus the optical fibers secured therein) which will create a gap between the optical fibers that results in significant signal loss. In addition, because such ferrules contain a significant amount of silica, which is the same hard material from which optical fibers are formed, any chips or debris from the ferrule that become trapped between aligned optical fibers may cause damage to the polished end surfaces or faces of the fibers which can also result in significant signal loss. This damage to the end faces of the optical fibers will exist even if the chips and debris are subsequently removed. Accordingly, an improved structure for reducing the likelihood of creating chips and debris during the mating of optical fiber connectors is desired.

### SUMMARY OF THE PRESENT DISCLOSURE

A multi-fiber ferrule includes a ferrule body made of a first material and has at least one alignment passage in the front face. The alignment passage has first and second sections. An insert is positioned within the first section of the alignment passage and is formed of a second material that is tougher than the first material. The insert has an insert hole coaxial with a central axis of the alignment passage.

A multi-fiber ferrule for positioning a plurality of optical fibers includes a ferrule body made of a first material and has a front face and an opposed rear face. A plurality of fiber receiving bores extend between the front and rear faces with each receiving an end portion of an optical fiber therein. The ferrule body also has a pair of spaced apart alignment passages in the front face with each alignment passage configured to receive an alignment member in order to align the multi-fiber ferrule with another component. Each alignment passage has first and second sections. The first section has a first length extending from proximate the front face to a transition spaced from the front face and with a first cross-sectional dimension adjacent the front face. The second section has a second length extending from the transition to a second position located between the transition position and the rear face and with a second cross-sectional dimension adjacent the second position. The second cross-sectional dimension is less than the first cross-sectional dimension. An insert is positioned within the first section of the alignment passage and is formed of a second material that is tougher than the first material. The insert has an insert hole coaxial with a central axis of the alignment passage.

If desired, a cross-sectional dimension of the insert hole may be generally equal to the second cross-sectional dimension. Each alignment passage may extend between the front and rear faces of the ferrule body. Each alignment passage may be generally cylindrical and the first and second sections may be positioned along the central axis of the alignment passage. The first section may have a larger diameter adjacent the front face than the second section adjacent the transition.

The first section has a first diameter generally adjacent the transition and a second diameter at the front face. The second diameter may be greater than the first diameter. The first section may expand radially outward in a generally uniform manner from the transition to the front face. The ferrule body may be a one-piece injection molded member. The ferrule body may be formed of a molded resin with a dimensional stabilizing additive. The ferrule body may be formed of PPS with up to approximately 60% SiO₂ by weight.

An optical fiber assembly includes a plurality of optical fibers and a ferrule structure having a front face, at least one elongated alignment receptacle extending through the front face and a plurality of fiber receiving bores. The alignment receptacle is configured to receive an alignment member in order to align the optical fiber assembly with another component and each fiber receiving bore has an end portion of a respective optical fiber therein. The ferrule structure has a ferrule body made of a resin and dimensional stabilizing material and a shoulder in the front face extending around a portion of the alignment passage adjacent the front face. The shoulder is formed of a second material tougher than the resin and dimensional stabilizing material of the ferrule body.

If desired, the ferrule structure may further include a pair of alignment receptacles in the front face with the alignment receptacles located on opposite sides of the fiber receiving bores. The alignment receptacle may be generally cylindrical. Each alignment receptacle has first and second sections along a central axis of the alignment receptacle. The first section may be located adjacent the front face and formed of the second material and the second section may be spaced from the front face and formed of the resin and dimensional stabilizing material. The ferrule body may have an enlarged opening adjacent the front face and the shoulder may be positioned within the enlarged opening. The ferrule body may be a one-piece injection molded member. The ferrule body may be formed of PPS with up to approximately 60% SiO₂ by weight.

A method of manufacturing a multi-fiber ferrule for positioning a plurality of optical fibers includes forming a ferrule body of a first material with the ferrule body having a front face and an opposed rear face and a plurality of optical fiber receiving holes extending therebetween. The ferrule body also has at least one alignment passage in the front face and is configured to receive an alignment member in order to align the multi-fiber ferrule with another component. An insert of a second material tougher than the first material is positioned within the alignment passage at a location generally adjacent the front face of the ferrule body. The insert has an insert hole aligned with a central axis of the alignment passage of the ferrule body.

If desired, the method may also include the step of polishing the insert adjacent the front face of the ferrule body. The forming step may include molding the ferrule body as a one-piece member. The molding step may include molding the ferrule body of a resin with a dimensionally stabilizing additive. The positioning step may include inserting a predetermined amount of the second material into a portion of the alignment passage adjacent the front face of the ferrule body. The method may include inserting ends of optical fibers within the fiber receiving holes and applying the second material to secure the ends of optical fibers positioned within the optical fiber receiving holes. The insert and ends of the optical fibers may be polished generally simultaneously after the insert is positioned in the alignment passage. The method may further include removing a portion of the ferrule body adjacent the front face to form a recess in which the insert is located. The removing step may include creating a tapered recess in the front face of the ferrule body aligned with the alignment passage. The method may further include positioning a pin in the alignment passage prior to positioning the insert, removing the pin and subsequently polishing the insert.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 is a perspective view of a ferrule configured to receive a plurality of optical fibers;

FIG. 2 is a cross-sectional view of the ferrule taken generally along Line 2-2 of FIG. 1 with optical fibers shown in phantom;

FIG. 3 is an enlarged, fragmented view of a portion of FIG. 2 together with a mating ferrule prior to mating the ferrules together;

FIG. 4 is a fragmented side view of a portion of a ferrule body depicting an alignment passage after an initial manufacturing step;

FIG. 5 is a fragmented side view of a portion of the ferrule body similar to FIG. 4 but depicting a machine tool aligned with the alignment passage;

FIG. 6 is a fragmented side view of a portion of the ferrule similar to FIG. 5 but with an enlarged recess at one end of the alignment passage adjacent the front face of the ferrule body after the machine tool has engaged the ferrule body and with a pin inserted into the alignment passage;

FIG. 7 is a fragmented side view of a portion of the ferrule body similar to FIG. 6 but with a second material positioned both in the recess at one end of the alignment passage adjacent the front face of the ferrule and on the front face of the ferrule and with the pin in the alignment passage; and

FIG. 8 is a fragmented side view of a portion of the ferrule similar to FIG. 7 but with the alignment pin removed and the epoxy on the front face of the ferrule polished to create a flat front face and a fully formed alignment receptacle.

### DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

Referring to FIG. 1, a multi-fiber MT type ferrule 10 is illustrated. Such ferrule 10 includes a one-piece or unitary body 12 that is generally rectangular, includes a generally flat front face 14 and a generally flat rear face 16. The ferrule body 12 includes two rows of twelve generally cylindrical fiber receiving holes or bores 18 that extend through the body from the rear face 16 to the front face 14. Ferrule 10 may have greater or fewer fiber receiving holes 18 if desired. In addition, ferrule body 12 also includes a pair of alignment holes or receptacles 20 positioned on opposite sides of the array of fiber receiving holes 18. As depicted, alignment holes 20 are generally cylindrical and extend from front face 14 to rear face 16. However, in some embodiments, the holes 20 may not extend all of the way to rear face 16, may not have a uniform cross-section (such as the cylinder depicted) but rather may be tapered or stepped as disclosed in U.S. Pat. No. 7,527,436 or may have a uniform, non-circular cross-section such as a hexagonal cross-section. In a typical MT ferrule, the alignment holes have a diameter of approximately 700 microns.

It should be noted that in this description, representations of directions such as up, down, left, right, front, rear, and the like, used for explaining the structure and movement of each part of the disclosed embodiment are not intended to be absolute, but rather are relative. These representations are appropriate when each part of the disclosed embodiment is in the position shown in the figures. If the position or frame of reference of the disclosed embodiment changes, however, these representations are to be changed according to the change in the position or frame of reference of the disclosed embodiment.

Ferrule body 12 is formed of a resin capable of being injection molded such as PPS or Ultem® and includes an additive such as silica (SiO₂) that is used to increase the dimensional characteristics, strength and stability of the resin. A chip or impact resistant shoulder or rim portion 30 adjacent front face 14 of body 12 and immediately surrounding alignment hole 20 is made of a second material, such as an epoxy resin, urethane or silicone that is tougher or less friable than the PPS—SiO₂ material with which the ferrule body is formed. Although there are different measures of toughness, in general, toughness is a measure of a material's ability to absorb energy or withstand an impact before fracturing. As such, contact surface 32 on front face 14 immediately surrounding alignment hole 20 is less likely to chip or be damaged during the process of mating two ferrules 10 together than a front face 14 that is formed of only PPS—SiO₂ or another similar material.

Referring to FIG. 2, it can be seen that the ferrule 10 has a generally cylindrical alignment hole 20 that is formed of a first section 21 extending from the front face 14 rearward along a length “a” and ending at a transition point 22 and a second section 23 extending from the transition point 22 rearward along a length “b” and ending at rear face 16. The first section 21 is defined by a chip or impact resistant material such as epoxy and is generally conical in shape while the second section is defined by a resin with an additive such as PPS—SiO₂. Ferrule body 12 has a passage 24 defined by a recessed or enlarged section 25 generally along the first section 21 of alignment hole 20 and an alignment section 26 along second section 23 of alignment hole 20. Enlarged section 25 has a generally tapered lead-in in which chip resistant shoulder 30 is positioned. More specifically, in the embodiment shown herein, the enlarged section 25 of ferrule body 12 surrounding first section 21 of alignment hole 20 has tapered sidewalls 27 with the largest diameter at front face 14 and with the diameter tapering linearly so as to be identical to that of second section 23 at transition point 22. In other words, ferrule body 12 has a first, enlarged diameter section 25 corresponding to length “a” and a second smaller diameter alignment section 26 corresponding to length “b.” Since the diameter of section 25 tapers linearly, the diameters of first section 25 and second section 26 are equal at transition point 22. Chip resistant shoulder 30 is positioned within the enlarged section 25 of ferrule body 12 and defines the first section 21 of the alignment hole 20.

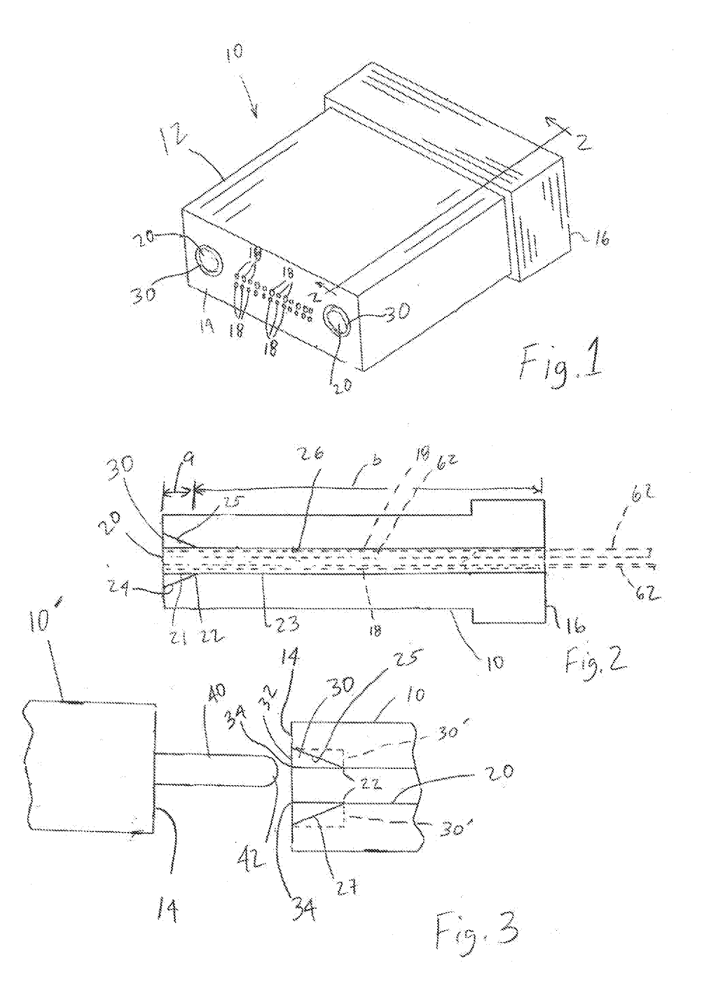

Although depicted as a generally conical shape with alignment hole 20 extending therethrough, chip resistant shoulder 30 may take a variety of shapes. For example, the shoulder may be generally cylindrical as shown in phantom at 30′ in FIG. 3 or some other shape as desired. For example, if portion 30 is generally cylindrical, enlarged section 25 of ferrule body 12 will likewise have an enlarged opening corresponding in shape to the cylindrical shape of portion 30 including a constant diameter (rather than the taper of FIG. 2) such that the diameters of the first section 25 and the second section 26 of ferrule body 12 are not equal at transition point 22. In addition, rather than being formed of an epoxy resin in situ, chip resistant shoulder may be formed outside of the enlarged section and subsequently inserted therein. In such case, shoulder 30 may be formed of a tough fracture resistant material such as a urethane, silicone or another material having similar characteristics and may be secured, such as with an epoxy resin, within the enlarged section.

In some situations, it may be possible or desirable for the chip resistant portion 30 to extend along the entire length of the passage in the ferrule body. Shoulder 30 is wide enough that even with some misalignment of mating ferrules, pins 40 will contact shoulder 30 rather than front face 14 of the ferrule body 12. In general, it is desirable for pins 40 to engage a length of at least 400 microns within alignment hole 20 in order to maintain desired alignment of the ferrules and their optical fibers. Depending on the tolerances of the holes 20 and pins 40 and the materials used for and the length of the first section 21 and second section 23 of alignment hole 20, the length of desired engagement may be greater or less than 400 microns.

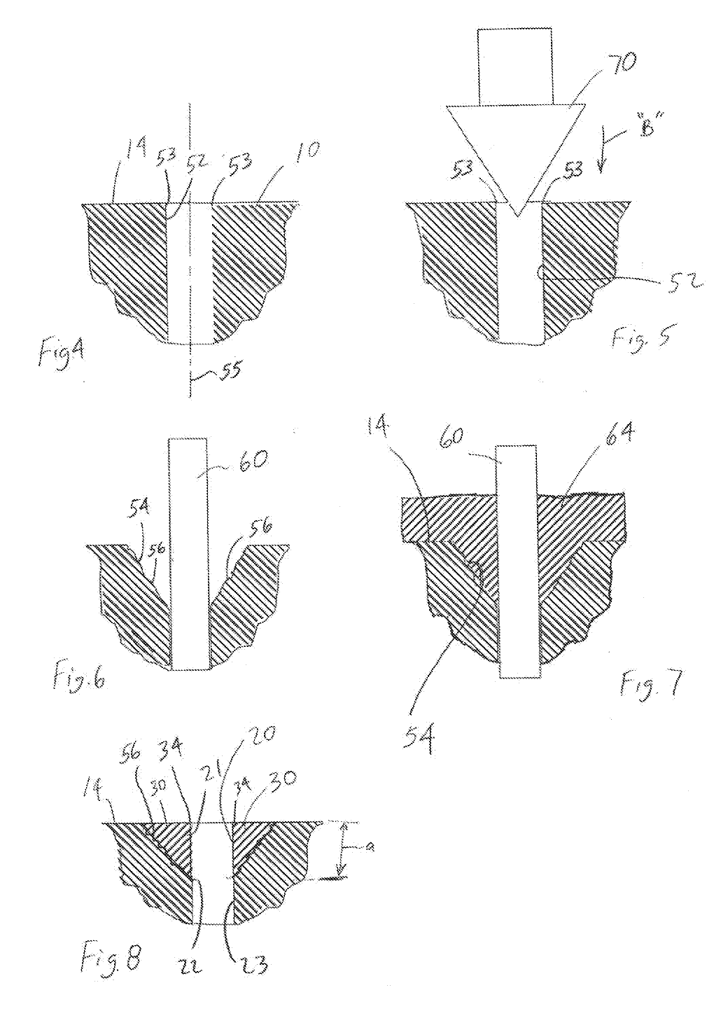

Referring to FIGS. 4-8, a sequence of a portion of the manufacturing process of ferrule 10 is shown. FIG. 4 depicts a one-piece, unitarily molded ferrule body 12 formed of a resin with an additive for maintaining dimensional characteristics, strength and stability such as PPS—SiO₂ with an initial cylindrical alignment passage 52 extending from the front face 14 generally rearwardly (downward as viewed in FIG. 4). Passage 52 is depicted as having a generally uniform, cylindrical diameter that is slightly larger than the diameter of alignment pin 40 as is known in the art. A machine tool or drill 70 is depicted in FIG. 5 aligned with and immediately prior to engaging the initial alignment passage 52. By moving the machine tool 70 in direction “B” relatively towards the front face 14 of ferrule body 12, the machine tool 70 engages the edges 53 of initial alignment passage 52 adjacent front face 14 in order to cut away or remove a portion of the front face 14 of ferrule body 12 to create enlarged, tapered recess 54 in the front face 14 along the central axis 55 extending through initial alignment passage 52. As depicted in FIG. 6, the recess 54 is generally tapered but other shapes may be utilized such a generally cylindrical recess. In addition, it should be noted that the tapered side walls 56 of recess 54 are somewhat roughened, rather than smooth, as a result of the drilling or machining process. This roughened surface may be desirable as it can increase the adhesion of the epoxy 64 to ferrule body 12.

After the recess 54 is formed, a pin 60 is inserted into the initial alignment hole passage 52. If desired, the pin 60 may be coated with a substance or material such as Teflon® to which the epoxy or other similar materials will not readily adhere. Either before or after pin 60 is secured within initial alignment passage 52, a plurality of optical fibers 62 are inserted into bores 18 in ferrule 10 (FIGS. 1 and 2). Epoxy 64 is then applied to secure the optical fibers 62 within bores 18 as is known in the art and also within recesses 54 to surround pin 60 within each recess 54 with a mass of epoxy as shown in FIG. 7. Generally, the epoxy used to secure optical fibers 62 within bores 18 is the same as that used to create chip resistant shoulder 30 in order to simplify the manufacturing process. In some situations, it may be possible or desirable to use two different epoxies. After applying the epoxy 64, it is cured in a known manner such as UV curing.

Referring to FIG. 8, after curing, pins 60 are removed and the front face 14 together with the optical fibers 62 are polished in order to achieve the desired flat front surface 14 of ferrule 10 as well as the desired polished end faces of optical fibers 62. After polishing, the mass of epoxy 64 adjacent front face 14 has filled in recess 54 with the tough epoxy material in the form of tapered chip resistant shoulder 30 as shown in FIGS. 1-3 and 8. As such, it can be seen that alignment hole 20 is formed of a chip resistant first section 21 having a length “a” that extends from the front face 14 to transition point 22. The remainder of alignment hole 20 is formed of a second section 23 having a length “b” that extends from transition point 22 to the rearward edge of the alignment hole. This structure creates a generally cylindrical alignment hole 20 that includes a tough, chip resistant contact surface or shoulder 30 that is less likely to be chipped or damaged or create particles that will reduce or negatively impact the performance of the ferrules 10.

In use, when it is desired to mate two ferrules 10, 10′ together, the ferrules are generally aligned in a pre-alignment position as depicted in FIG. 3 with alignment pins 40 of ferrule 10′ generally aligned with alignment holes 20 of ferrule 10. Since the pre-alignment will generally be imperfect and the size difference between the outside diameter of alignment pins 40 and the inside diameter of alignment holes 20 is very small, the tip 42 of each alignment pin 40 will likely engage the edge 34 of the chip resistant shoulder 30. The increased toughness of impact resistant portion 30 (as compared to the PPS—SiO₂ ferrule body 12) results in ferrule 10 being more resistant to withstanding the impact of the alignment pins 40 without chipping or breaking away the edges 34 surrounding holes 20 and creating debris that can become trapped between the front faces 14 of the mating ferrules 10, 10′ or engage the contact surfaces of the optical fibers and physically damage the optical fiber faces.

While a preferred embodiment of the Present Disclosure is shown and described, it is envisioned that those skilled in the art may devise various modifications without departing from the spirit and scope of the foregoing Description and the appended Claims.

What is claimed is:

1. A multi-fiber ferrule for positioning a plurality of optical fibers, the multi-fiber ferrule comprising:
a ferrule body made of a first material, the ferrule body including a front face, an opposed rear face, a pair of spaced-apart alignment passages and a plurality of fiber-receiving bores extending therebetween, each bore receiving an end portion of one optical fiber therein;
each alignment passage being configured to receive an alignment member in order to align the multi-fiber ferrule with another component, and including first and second sections, the first section having a first length extending from proximate the front face to a transition spaced from the front face, and a first cross-sectional dimension adjacent the front face, the second section having a second length extending from the transition to a second position located between the transition position and the rear face, a second cross-sectional dimension adjacent the second position, the second cross-sectional dimension being less than the first cross-sectional dimension; and
an insert positioned within the first section of the alignment passage, the insert being formed of a second material tougher than the first material and having an insert hole coaxial with a central axis of the alignment passage.

2. The multi-fiber ferrule of claim 1, wherein a cross-sectional dimension of the insert hole is generally equal to the second cross-sectional dimension.

3. The multi-fiber ferrule of claim 1, wherein each alignment passage extends between the front and rear faces of the ferrule body.

4. The multi-fiber ferrule of claim 1, wherein each alignment passage is generally cylindrical.

5. The multi-fiber ferrule of claim 4, wherein the first and second sections are positioned along the central axis of the alignment passage.

6. The multi-fiber ferrule of claim 5, wherein the first section has a larger diameter adjacent the front face than the second section adjacent the transition.

7. The multi-fiber ferrule of claim 6, wherein the first section has a first diameter generally adjacent the transition and a second diameter at the front face, the second diameter being greater than the first diameter.

8. The multi-fiber ferrule of claim 7, wherein the first section expands radially outward in a generally uniform manner from the transition to the front face.

9. The multi-fiber ferrule of claim 1, wherein the ferrule body is a one-piece injection molded member.

10. The multi-fiber ferrule of claim 1, wherein the ferrule body is formed of a molded resin with a dimensional stabilizing additive.

11. The multi-fiber ferrule of claim 1, wherein the ferrule body is formed of PPS with up to approximately 60% SiO₂ by weight.

12. An optical fiber assembly, comprising:
a plurality of optical fibers; and
a ferrule structure, the ferrule structure including a front face, at least one elongated alignment receptacle extending through the front face and a plurality of fiber receiving bores, the alignment receptacle configured to receive an alignment member in order to align the optical fiber assembly with another component, each fiber receiving bore having an end portion of a respective optical fiber therein;
wherein the ferrule structure includes a ferrule body made of a resin-silica material and a shoulder in the front face extending around a portion of the alignment passage adjacent the front face, the shoulder being formed of a second material tougher than the resin silica material of the ferrule body.

13. The optical fiber assembly of claim 12, wherein the ferrule structure further includes a pair of alignment receptacles in the front face, the alignment receptacles being located on opposite sides of the fiber receiving bores.

14. The optical fiber assembly of claim 12, wherein the alignment receptacle is generally cylindrical.

15. The optical fiber assembly of claim 12, wherein each alignment receptacle has first and second sections along a central axis of the alignment receptacle, the first section being located adjacent the front face and formed of the second material and the second section being spaced from the front face and formed of the resin-silica material.

16. The optical fiber assembly of claim 12, wherein the ferrule body has an enlarged opening adjacent the front face and the shoulder is positioned within the enlarged opening.

17. The optical fiber assembly of claim 12, wherein the ferrule body is a one-piece injection molded member.

18. The optical fiber assembly of claim 12, wherein the ferrule body is formed of PPS with up to approximately 60% SiO₂ by weight.

19. A method of manufacturing a multi-fiber ferrule for positioning a plurality of optical fibers, comprising the steps of:
forming a ferrule body of a first material, the ferrule body having a front face, an opposed rear face, a plurality of optical fiber receiving holes extending therebetween and at least one alignment passage in the front face, the ferrule body configured to receive an alignment member in order to align the multi-fiber ferrule with another component; and
positioning an insert of a second material tougher than the first material within the alignment passage at a location generally adjacent the front face of the ferrule body, the insert having an insert hole aligned with a central axis of the alignment passage of the ferrule body.

20. The method of claim 19, further including the step of polishing the insert adjacent the front face of the ferrule body.

21. The method of claim 19, wherein the forming step includes molding the ferrule body as a one-piece member.

22. The method of claim 21, wherein the molding step includes molding the ferrule body of a resin with a dimensional stabilizing additive.

23. The method of claim 19, wherein the positioning step includes inserting a predetermined amount of the second material into a portion of the alignment passage adjacent the front face of the ferrule body.

24. The method of claim 23, further including the step of inserting ends of optical fibers within the fiber receiving holes and applying the second material to secure the ends of optical fibers positioned within the optical fiber receiving holes.

25. The method of claim 24, wherein the inserted ends of the optical fibers are polished generally simultaneously after the insert is positioned in the alignment passage.

26. The method of claim 19, further including the step of removing a portion of the ferrule body adjacent the front face to form a recess in which the insert is located.

27. The method of claim 26, wherein the removing step includes creating a tapered recess in the front face of the ferrule body aligned with the alignment passage.

28. The method of claim 27, further including the step of positioning a pin in the alignment passage prior to positioning the insert, removing the pin and subsequently polishing the insert.
